(19) United States
(12) Patent Application Publication
(10) Pub. No.: US 2023/0067242 A1
(43) Pub. Date: Mar. 2, 2023

(54) PROCESS FOR PREPARATION OF SUPERABSORBENT POLYMER

(71) Applicant: UPL LTD, Mumbai (IN)

(72) Inventors: Prashant Vasant Kini, Mumbai (IN); Vilas Manikant Mukadam, Mumbai (IN); Maneesh Sharma, Mumbai (IN); Janardan Tiwari, Mumbai (IN)

(21) Appl. No.: 17/895,733

(22) Filed: Aug. 25, 2022

(30) Foreign Application Priority Data
Aug. 27, 2021 (IN) 202121038905

(51) Int. Cl. C09K 17/20; C08F 251/00; B01J 20/26; B01J 20/28

(52) U.S. Cl. CPC C09K 17/20; C08F 251/00; B01J 20/267; B01J 20/28004; B01J 20/28016; C08F 2810/20; A01C 21/00

(57) ABSTRACT

Described herein is a process for preparation of a superabsorbent polymer with high fluid absorptivity. Also described is a composition including the superabsorbent polymer.

### CROSS-REFERENCE TO RELATED APPLICATIONS

This application claims priority to Indian Application 202121038905 filed on Aug. 27, 2021, which is incorporated herein by reference in its entirety.

### FIELD OF INVENTION

The present invention relates to a process for preparation of superabsorbent polymer. The present invention also relates to a composition comprising said superabsorbent polymer.

### BACKGROUND OF INVENTION

Superabsorbent polymers absorb water or fluids several times their weight. Superabsorbent polymer(s) (SAP) improve the supply of water in the soil and are therefore used in agriculture.

Various superabsorbent polymers are known in the art. Such superabsorbent polymers may be made from polyacrylamide copolymer, cross-linked carboxymethylcellulose, polyvinyl alcohol copolymers, cross-linked polyethylene oxide, starch grafted copolymer of polyacrylonitrile, etc. The water absorbance of most superabsorbent polymers has been known to decrease considerably in the presence of salts. Soil incorporated superabsorbent polymers or those that are mixed with fertilizers have been known to suffer from decreased absorbance capacity due to the presence of salts in the soil or fertilizer. Studies have been carried out to study the effect of such salts such as those carried out by Daniel C. Bowman, Richard Y. Evans, and J. L. Paul., J. Amer. Soc. Hort. Sci. May 1990 115:382-386, Fertilizer Salts Reduce Hydration of Polyacrylamide Gels and Affect Physical Properties of Gel-amended Container Media. The paper discusses the decrease in polymer absorption capacity when mixed with salts. It was observed that soluble salts dramatically affect absorption by hydrophilic polyacrylamide gels.

Agriculture requires the use of many compounds to ensure good yields and healthy crops. Most of the fertilizers and nutrients added to the soil are salts that in some way contribute to the improvement in the crops. Salts are also naturally present in the soil, which also contribute to the increased salinity of the soil. In drought prone areas and areas where water management is essential, the salinity in the soil is higher, as water required to wash these salts away is scarce. In such soils, where water is scarce or where water management is required or even where normal salts are added to the soil, addition of superabsorbent polymers may not result in the desired effect that is, increased water availability. Salts in the environment around the superabsorbent polymer influence the performance capacity of the polymer.

The known preparation process for such superabsorbent polymers includes a process by reverse phase suspension polymerization and a process by aqueous solution polymerization.

U.S. Pat. No. 7,459,501 discloses and claims a process for preparing SAP wherein SAP is prepared by graft polymerizing a monomer on starch in the presence of a thermal initiator like ammonium persulfate at 170° F.

U.S. Pat. No. 8,507,607 discloses a continuous process for graft polymerizing a carbohydrate with one α, β-unsaturated carboxylic acid derivative in the presence of a catalyst wherein the polymerization is thermally initiated polymerization under substantially adiabatic conditions.

WO2019/011793 relates to a process for producing superabsorbent polymer particles, comprising surface postcrosslinking, classifying the surface postcrosslinked superabsorbent polymer particles, deagglomerating the separated oversize fraction using a roll crusher and recycling the disintegrated oversize fraction before or into the classification of the surface post crosslinked superabsorbent polymer particles.

Thus, there is a need in the art for simple and industrially viable process of preparing superabsorbent polymer in granular form. Accordingly, the present invention provides a feasible and economical route for the preparation of superabsorbent polymer by overcoming the problem faced during the preparation of SAP. Surprisingly it has been found that the present invention provides superabsorbent polymer with desired properties specifically the particles of superabsorbent polymer have high absorbance capacity and retention properties for aqueous fluids.

### SUMMARY OF THE INVENTION

In an aspect, the present disclosure provides a process for the preparation of superabsorbent polymer.

In another aspect, the present disclosure provides a process for the preparation of a superabsorbent polymer comprising graft polymerizing a monomer on a polysaccharide at room temperature.

In another aspect, the present disclosure provides a process for the preparation of a superabsorbent polymer comprising graft polymerizing a monomer of acrylic acid compound on a polysaccharide, wherein said process is acrylamide-free process.

In another aspect, the present disclosure provides a process for preparation of superabsorbent polymer comprising:

a) graft polymerizing a monomer on a polysaccharide surface to form a copolymer; and

b) neutralizing the copolymer to obtain a superabsorbent polymer,

wherein said process is carried out at room temperature.

In another aspect, graft polymerization of the monomer on the polysaccharide is carried out in presence of a catalytic system.

In an aspect, the present disclosure provides a superabsorbent polymer having a particle size for example in the range of 5000 micron to 100 micron.

In an aspect, the present disclosure provides a superabsorbent polymer having a water absorbance capacity in the range of 100 to 1500 g/g.

In an aspect, the present disclosure provides a composition comprising a superabsorbent polymer produced by the present invention optionally with agrochemically acceptable excipients or additives.

In an aspect, the present invention provides a kit comprising:

i) a container comprising a superabsorbent polymer prepared according to the present disclosure optionally with at least one plant advantageous additive; and

ii) an instruction manual instructing a user to administer the content to a locus.

### DETAILED DESCRIPTION OF THE INVENTION

Within the context of this specification, each term or phrase below will include the following meaning or meanings:

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

The term “about” or “approximately” as used herein is inclusive of the stated value and means within an acceptable range of deviation for particular value as determined by one of ordinary skill in the art, considering the measurement in question and the error associated with measurement of the particular quantity (i.e., the limitations of the measurement system). For example, “about” can mean within one or more standard deviations, or within ±10 or ±5 of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

Those skilled in the art will recognize that the methods and compositions disclosed herein may be practiced without one or more of the specific details described, or with other methods, components, materials, etc. In some cases, well-known materials, components or method steps are not shown or described in detail. Furthermore, the described method steps, compositions, etc., may be combined in any suitable manner in one or more embodiments. It will also be readily understood that the methods and compositions of the embodiments as generally described herein could be arranged and designed in a wide variety of different configurations.

The order of the steps or actions of the process described in connection with the embodiments disclosed may be changed as would be apparent to those skilled in the art. Thus, any order in the detailed description is for illustrative purposes only and is not meant to imply a required order.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

As used herein, the term “room temperature” refers to temperatures for example from 15° C.-45° C., 15° C. to 30° C., and 15° C. to 24° C., 16° C. to 21° C., 20° C. to 30° C., 30° C. to 35° C. Such temperatures may vary by +5° C. to −5° C.

The term “SAP” as used herein means superabsorbent polymer and is used synonymously in the description.

The term “water absorption” as used herein means property of absorbing water when a superabsorbent polymer is exposed to water. Water absorption capacity (WAC) can be determined by adding water or an aqueous solution to material, followed by sieving and quantification of the water retained by the gelled material in the sieve.

The term “locus” as used herein shall denote the vicinity of a desired crop. The term crop shall include a multitude of desired crop plants or an individual crop plant growing at a locus.

In any aspect or embodiment described hereinbelow, the phrase comprising may be replaced by the phrases “consisting of” or “consisting essentially of” or “consisting substantially of” or “containing” In these aspects or embodiment, the combination or composition described includes or comprises or consists of or consists essentially of or consists substantially of the specific components recited therein or adjuvants or excipients not specifically recited therein.

The terms “superabsorbent polymer” or “SAP” or “polymer gel” refer to water swellable polymers that can absorb water many times their weight in an aqueous solution. Without wishing to be bound by theory, the term superabsorbent polymers also applies to polymers that absorb water as well as de-sorb the absorbed water. The superabsorbent polymer may be selected from, but is not limited to, water-swellable or water absorbing or water-retentive polymers such as cross-linked polymers that swell without dissolving in the presence of water, and may, absorb at least 10, 100, 1000, or more times their weight in water.

In an aspect, the present disclosure provides a process for production of a superabsorbent polymer.

In another aspect, the present disclosure provides a process for the preparation of polysaccharide-g-poly (2-propenamide-co-2-propenoic acid) or salts thereof.

In another aspect, the present disclosure provides a process for the preparation of starch-g-poly (2-propenamide-co-2-propenoic acid) or salts thereof.

In another aspect, the present disclosure provides an efficient process for the production of a superabsorbent polymer which shows an increase in yield, is cost effective, and is made by an environmentally friendly technique.

In another aspect, the present disclosure provides a superabsorbent polymer having a high-water absorbing capacity.

In an aspect, the present disclosure provides a superabsorbent polymer having a water absorbance capacity in the range of 100 to 1500 g/g.

In another aspect, the present disclosure provides a starch grafted polymer namely a superabsorbent polymer having a high water absorbing capacity ranging from 500 g/g to 980 g/g, preferably in the range of 650 g/g to 800 g/g.

In an aspect, the present disclosure provides a process for preparation of a superabsorbent polymer comprising graft polymerising a monomer on a polysaccharide at room temperature.

In another aspect, the present disclosure provides a process for preparation of a superabsorbent polymer comprising graft polymerising a monomer of acrylic acid on starch at room temperature.

In an embodiment, the mole ratio of the polysaccharide to the monomer is in the range of about 1:10 to about 10:1.

In an aspect, the present disclosure provides a process comprising graft polymerizing a monomer onto a starch to form a starch graft copolymer, wherein the monomer comprises at least one α, β-unsaturated nitrile or carboxylic acid derivative. In embodiments, the monomer comprises acrylic acid, 2-acrylamido-2-methyl-propanesulfonic acid, methacrylic acid, vinyl sulfonic acid, ethyl acrylate, potassium acrylate, derivatives thereof, and mixtures thereof.

The examples of monomers used in the invention include, but are not limited to, acrylic acid or methacrylic acid, sulfonic acids, such as 2-acrylamido-2-methyl-propanesulfonic acid (AMPS), vinyl sulfonic acid, acrylates, such as ethyl acrylate and potassium acrylate.

In an embodiment, the monomer is acrylic acid.

In an embodiment, graft polymerization of the monomer on the polysaccharide is carried out in presence of a catalytic system.

In an embodiment, the catalytic system comprises ammonium persulfate, a cross linking agent, and ascorbic acid.

In an embodiment, the cross linking agent comprises glycerides; diepoxides; diglycidyls; cyclohexadiamide; methylene bis-acrylamide; bis-hydroxyalkylamides, such as bis-hydroxypropyl adipamide; formaldehydes, such as urea-formaldehyde, Tetraethyleneglycol diacrylate (TEGDA), 1,6-hexanediol dimethacrylate, 1,3-butanediol dimethacrylate and melamine-formaldehyde resins; isocyanates including di- or tri-isocyanates; epoxy resins, typically in the presence of a base catalyst; and derivatives and mixtures thereof

In another embodiment, acrylic acid can be graft polymerized onto starch or other polysaccharides in the absence of acrylamide to obtain a copolymer.

In another embodiment, the obtained copolymer is a polysaccharide grafted copolymer.

In an embodiment, the polysaccharide is starch or derivatives thereof.

The starch used in the above-described process include starches, flours, and meals. For example the starches include native starches (e.g., corn starch (Pure Food Powder, manufactured by A. E. Staley), waxy maize starch (Waxy 7350, manufactured by A. E. Staley), wheat starch (Midsol™ 50, manufactured by Midwest Grain Products), potato starch (Avebe, manufactured by A. E. Staley)), dextrin starches (e.g., Stadex® 9, manufactured by A. E. Staley), dextran starches (e.g., Grade 2P, manufactured by Pharmachem Corp.), corn meal, peeled yucca root, unpeeled yucca root, oat flour, banana flour, and tapioca flour. The starch may be gelatinized to provide optimal absorbency.

In an embodiment, the starch is gelatinized corn starch.

Furthermore, according to an embodiment, the mole ratio of starch to the monomer is in the range of 1:10 to 10:1.

In an alternative embodiment, other polysaccharides, such as cellulose or derivatives thereof, may be used instead of starch. Accordingly, the monomers heretofore described may be graft polymerized onto cellulose for purposes of agricultural applications.

In another embodiment, the present disclosure provides a process for production of superabsorbent polymer, the process comprising

a) graft polymerizing a monomer on a polysaccharide to form a copolymer; and

b) neutralizing the copolymer to obtain the superabsorbent polymer.

In an embodiment, the superabsorbent polymer is a starch based superabsorbent polymer.

In an embodiment, the superabsorbent polymer is Zeba®.

In an embodiment, the superabsorbent polymer is polysaccharide-g-poly (2-propenamide-co-2-propenoic acid) or salts thereof.

In an embodiment, the superabsorbent polymer is starch-g-poly (2-propenamide-co-2-propenoic acid) or salts thereof.

In an embodiment, the superabsorbent polymer obtained using the process as disclosed in the present disclosure comprises a copolymer of acrylamide and sodium acrylate; hydrolyzed starch-polyacrylonitrile; 2-propenenitrile homopolymer, hydrolyzed, sodium salt or poly(acrylamide co-sodium acrylate) or poly(2-propenamide-co-2-propanoic acid, sodium salt); starch-g-poly(2propenamide-co-2-propanoic acid, mixed sodium and aluminium salts); starch-g-poly(2-propenamide-co-2-propanoic acid, potassium salt); poly(2-propenamide-co-2-propanoic acid, sodium salt); poly-2-propanoic acid, sodium salt; starch-gpoly(acrylonitrile) or poly(2-propenamide-co-sodium acrylate); starch/acrylonitrile copolymer; crosslinked copolymers of acrylamide and sodium acrylate; acrylamide/sodium polyacrylate crosslinked polymers; anionic polyacrylamide; starch grafted sodium polyacrylates; acrylic acid polymers, sodium salt; crosslinked potassium polyacrylate/polyacrylamide copolymers; sodium polyacrylate; superabsorbent polymer laminates and composites; partial sodium salt of crosslinked polypropenoic acid; potassium polyacrylate, lightly crosslinked; sodium polyacrylate, lightly crosslinked; sodium polyacrylates; poly(sodiumacrylate) homopolymer; polyacrylamide polymers, carrageenan, agar, alginic acid, guar gums and its derivatives, and gellan gum. Specific superabsorbent polymers include a crosslinked copolymer of acrylamide and potassium acrylate.

In an embodiment, the process is carried out at room temperature.

In an embodiment, graft polymerization is carried out in presence of a catalytic system comprising ammonium persulfate, a cross linking agent, and ascorbic acid.

In an embodiment, nitrogen gas is purged at the stage of graft polymerization to remove oxygen.

In an embodiment, the process for preparing superabsorbent polymer by graft polymerizing a monomer onto a starch to form a starch graft copolymer is carried out at room temperature.

In another embodiment, the process for preparing a superabsorbent polymer comprises the steps of

a) graft polymerizing a monomer onto starch to form a starch graft copolymer;

b) neutralizing the starch graft copolymer to obtain the superabsorbent polymer; and

c) isolating the superabsorbent polymer.

In an embodiment, the monomer is graft polymerized onto a starch at room temperature.

In an embodiment, graft polymerization of the monomer onto a starch is carried out in presence of a catalytic system.

In an embodiment the catalytic system comprises of ammonium persulfate, a cross linking agent, and ascorbic acid.

The process of graft polymerization further comprises a crosslinking agent.

The examples of cross-linking agents may include: glycerides; diepoxides; diglycidyls; cyclohexadiamide; methylene bis-acrylamide; bis-hydroxyalkylamides, such as bis-hydroxypropyl adipamide; formaldehydes, such as urea-formaldehyde, tetraethyleneglycol diacrylate (TEGDA), 1,6-hexanediol dimethacrylate, 1,3-butanediol dimethacrylate and melamine-formaldehyde resins; isocyanates including di- or tri-isocyanates; epoxy resins, typically in the presence of a base catalyst; and derivatives and mixtures thereof.

In an embodiment, the process for preparation of superabsorbent polymer is a batch process or continuous process.

Advantageously, the catalytic system used in the process aids to achieve polymerization at room temperature and provides the product with improved water absorbance capacity and strength.

Another advantage associated with the present disclosure is that the equipment required for the heating and cooling for a thermally initiated catalytic system is totally avoided which results in cost reduction of the process at commercial scale.

In an embodiment, once a starch graft copolymer is formed, the pH of the starch graft copolymer may be adjusted to a desired value for the particular agricultural application. Different pH values may be desirable depending upon the type of soil and the type of crop to which the SAPs will be applied to. The resulting pH for most agricultural applications typically will range from about 6.0 to about 8.0, preferably about 7.0.

In an embodiment, the neutralization of a copolymer is carried out using an alkali metal alkoxide, a hydroxides of an alkali metal, a carbonate of an alkali metals, a bicarbonate salt of an alkali metal, or a mixture thereof.

In an embodiment, the neutralization of the starch graft copolymer is performed using alkali potassium hydroxide, potassium methoxide, potassium carbonate, potassium bicarbonate, or a mixture thereof.

In an embodiment, after neutralizing, the starch graft copolymer is then isolated. In an exemplary embodiment, the neutralized dough of the polymer is washed with a solvent for example alcohol, to obtain a granulated product.

In an exemplary embodiment, the neutralized dough of the polymer is granulated by mixing with a solvent in twin screw reactor in a continuous manner to obtain granules of SAP product.

In an embodiment, the solvent is an organic solvent.

In an embodiment, the solvent is an alcohol.

In another embodiment, the solvent may be selected from methanol or ethanol.

In an embodiment, the solvent is methanol.

In another embodiment, the process for preparing a superabsorbent polymer comprises the steps of

a) graft polymerizing a monomer onto starch to form a starch graft copolymer;

b) neutralizing the starch graft copolymer with a base selected from an alkali metal alkoxide, a hydroxide of an alkali metal, a carbonates of an alkali metal, a bicarbonate salt of an alkali metal, or a mixture thereof; and
c) isolating the superabsorbent polymer.

In an embodiment, the SAP obtained by the process disclosed in the present disclosure has a particle size of less than about 200 mesh. The desirable particle size may depend on the specific agricultural application intended. In one embodiment for agricultural applications that deposit the starch graft copolymer directly into the soil, the particle size may be less than 50 mesh, more particularly between about 5 mesh and 50 mesh, or between about 5 mesh and 25 mesh, or between about 8 mesh and about 25 mesh.

In an embodiment, the particle size of the superabsorbent polymer is in the range from 1 to 100 mesh. In another embodiment, the particle size of the superabsorbent polymer is in the range from 5 to 80 mesh. In another embodiment, the particle size of the superabsorbent polymer is in the range from 5 to 70 mesh. In another embodiment, the particle size of the superabsorbent polymer is in the range from 5 to 60 mesh. In another embodiment, the particle size of the superabsorbent polymer is in the range from 5 to 50 mesh. In another embodiment, the particle size of the superabsorbent polymer is in the range from 5 to 40 mesh. In another embodiment, the particle size of the superabsorbent polymer is in the range from 5 to 30 mesh. In another embodiment, the particle size of the superabsorbent polymer is in the range from 5 to 20 mesh. In another embodiment, the particle size of the superabsorbent polymer is in the range from 5 to 10 mesh.

In another embodiment, the particle size of the superabsorbent polymer is in the range from 4 to 30 mesh, preferably 4 to 16 mesh. In another embodiment, the particle size of the superabsorbent polymer is in the range from 8 to 16 mesh. In another embodiment, the particle size of the superabsorbent polymer is in the range from 16 to 30 mesh. In another embodiment, the particle size of the superabsorbent polymer is in the range from 30 to 70 mesh, preferably 30 to 60 mesh. In an embodiment, the particle size of the superabsorbent polymer is 100 mesh.

In an embodiment, the particle size, e.g., particle diameter, of the superabsorbent polymer is in the range from 5000 micron to 100 micron. In another embodiment, the particle size of the superabsorbent polymer is in the range from 4500 micron to 100 micron. In another embodiment, the particle size of the superabsorbent polymer is in the range from 4000 micron to 100 micron. In another embodiment, the particle size of the superabsorbent polymer is in the range from 3500 micron to 100 micron. In another embodiment, the particle size of the superabsorbent polymer is in the range from 3000 micron to 100 micron. In another embodiment, the particle size of the superabsorbent polymer is in the range from 2500 micron to 100 micron. In another embodiment, the particle size of the superabsorbent polymer is in the range from 2000 micron to 100 micron. In another embodiment, the particle size of the superabsorbent polymer is in the range from 1500 micron to 100 micron. In another embodiment, the particle size of the superabsorbent polymer is in the range from 1000 micron to 100 micron. In another embodiment, the particle size of the superabsorbent polymer is in the range from 500 micron to 100 micron. In another embodiment, the particle size of the superabsorbent polymer is in the range from 300 micron to 100 micron. In another embodiment, the particle size of the superabsorbent polymer is in the range from 200 micron to 100 micron. In another embodiment, the particle size of the superabsorbent polymer 100 micron.

In another aspect, the present disclosure provides a process of increasing the water absorption capacity of a superabsorbent polymer, the process comprising contacting the superabsorbent polymer according to the present disclosure with a plot of soil. Typically, the superabsorbent polymer product may be mixed with a solvent, such as water, to form a slurry. The resulting slurry may be applied to an agricultural medium such as a plant, root, seed, seedling, or directly to soil into which one of a plant, root, seed, or seedlings will be planted.

In an embodiment, a fertilizer or micronutrient may be added to the SAP product.

In an aspect, the present disclosure provides a composition comprising a superabsorbent polymer produced by the present invention optionally with agrochemically acceptable excipients or additives.

In an embodiment of the present disclosure, the agrochemical composition may further comprise one or more antifreeze agent, wetting agents, fillers, surfactants, anticaking agents, pH-regulating agents, preservatives, biocides, antifoaming agents, colorants, and other formulation aids.

In an aspect, the present disclosure provides a kit comprising a container with a superabsorbent polymer prepared by the process of the present disclosure optionally with at least one plant advantageous additive and an instruction manual instructing a user to administer the content to a locus.

The agricultural application of SAPs made by the above-described processes may result in earlier seed germination and/or blooming, decreased irrigation requirements, increased propagation, increased crop growth, increased crop production, and decreased soil crusting. Thus, SAPs made by the processes disclosed herein are desirable for forming and using a SAP in large-scale agricultural applications.

The advantage of the SAP of the present disclosure further lies in retaining the desired water absorption properties without subjecting to plasticizing conditions.

It will be understood that the specification and examples are illustrative but not limitative of the present invention and that other embodiments within the spirit and scope of the invention will suggest themselves to those skilled in the art. Other embodiments can be practiced that are also within the scope of the present invention. The following examples illustrate the invention, but by no means intend to limit the scope of the claims.

### EXAMPLES

### Example 1: Process for Preparation of Superabsorbent Polymers (Batch Process)

82 g of starch was hydrated in 700 g of water in a homogenizer for 2.5 hour at 85-90° C. This mass was then transferred to a reaction kettle. The reaction mixture was stirred at 23-26° C. and 125 g (100%) of acrylic acid was added, followed by addition of 392 mg Tetraethyleneglycol diacrylate (TEGDA) and 300 mg ammonium persulfate in 45 g water. The slurry obtained was then purged with nitrogen gas for 1 hour followed by the addition Ascorbic acid solution 150 mg in 100 ml water (purged with N₂ gas for 1 hour). The resultant thick mass was stirred for 2 hr and then neutralized with KOH solution (45%) after extrusion of the gel to pH 7.2-7.5. The dough was then washed with methanol (3.0 kg) to obtain granulated superabsorbent polymer. Weight—260 g, Yield—97% with moisture content 6-7% Water absorbing capacity (WAC)=752 g/g.

### Example 2: Process for Preparation of Superabsorbent Polymers (Batch Process)

82 g of starch was hydrated in 700 g of water in a homogenizer for 2.5 hour at 85-90° C. This mass was then transferred to a reaction kettle. The reaction mixture was stirred at 23-26° C. and 125 g (100%) of acrylic acid was added, followed by 329 mg 1,6-hexanediol dimethacrylate and 300 mg ammonium persulfate in 45 g water. The resultant slurry was purged with nitrogen gas for 1 hour, followed by addition of ascorbic acid solution 150 mg in 100 ml water (purged with N₂ gas for 1 hour). The thick mass was stirred for 2 hr and then neutralized with KOH solution after extrusion of the gel to pH 7.2-7.5. The dough was then washed with methanol (3.0 kg) to afford granulated product. Weight—260 g, yield—97% with moisture content 6-7% Water absorbing capacity (WAC)=502 g/g.

### Example 3: Process for Preparation of Superabsorbent Polymers (Batch Process)

82 g of starch was hydrated in 700 g of water in a homogenizer for 2.5 hour at 85-90° C. The resultant mass was then transferred to a reaction kettle and cooled. The reaction mixture was stirred at 23-26° C. and 125 g (100%) of acrylic acid was added, followed by 293 mg 1,3-butanediol dimethacrylate and 300 mg ammonium persulfate in 45 g water. The slurry was then purged with nitrogen gas for 1 hour followed by addition of Ascorbic acid solution 150 mg in 100 ml water. The resultant thick mass was stirred for 2 hr, extruded and then neutralized with KOH solution 45%, to pH 7.2-7.5. The dough was washed by stirring with methanol (3.0 kg) to obtain granulated product. Weight—260 g, Yield—97% with moisture content 6-7% Water absorbing capacity (WAC)=532 g/g

### Example 4: Process for Preparation of Superabsorbent Polymers (Continuous Process)

738 g of starch was hydrated in 6300 g of water in a homogenizer for 1 hr to prepare a mixture. To the resultant mixture, 1125 g of acrylic acid followed by 3.52 g TEGDA and 2.7 g ammonium persulfate was added. This mixture was introduced into a continuous twin screw reactor at the rate of 38.1 ml/min at 23-25° C. Through another port, simultaneously a solution of ascorbic acid 1.35 g in 900 ml water (under nitrogen) with a feed rate of 10 ml/min was added. The material coming out of the reactor was neutralized progressively in the next neutralization chamber where a solution of potassium hydroxide is fed at a rate of 7 ml/min. The neutralized dough coming out is then granulated by mixing with methanol in another twin-screw reactor in continuous manner Weight—260 g/h, Yield—97% with moisture content 6-7% Water absorbing capacity (WAC)=625 g/g

### Example 5: Process for Preparation of Superabsorbent Polymers (Pilot Scale Production)

738 g of starch was hydrated/gelatinized at 85° C. in 6300 g of water in a homogenizer for 2.5 hr in a bucket. The resultant mixture was cooled at 25° C. this was followed by the addition of 1125 g of acrylic acid followed by 3.53 g TEGDA. The mass was transferred to the ribbon paddle reactor and N₂ was purged. Parallelly, N₂ was purged into 900 ml water having 1.5 g ascorbic acid solution which was prepared in a separate vessel. After 45 minutes, 2.7 g APS (ammonium persulfate) was added to the slurry in the ribbon paddle reactor and N₂ purging was continued. Ascorbic acid solution was introduced into the ribbon paddle reactor after 15 minutes at 25-28° C. Stirring was done for 1 minute more and then RPM was reduced to 3-4. The dough formed was extruded and transferred back to the reactor for neutralized in the next neutralization chamber using a 45% solution of potassium hydroxide in 1 hour. The neutralized dough (pH 7-8) was then granulated by mixing with methanol and dried. Weight—2234 g, yield—93% with moisture content 5-7%. Water absorbing capacity (WAC)=809 g/g

### Example 6: Process for Preparation of Superabsorbent Polymers

82 g of starch was hydrated in 700 g of water in a homogenizer for 1 hour at 25° C. The resultant mass was then transferred to a reaction kettle. The reaction mass was stirred at 23-26° C. Followed by addition of 125 g (100%) of acrylic acid and, 392 mg TEGDA and 300 mg ammonium persulfate in 45 g water. Then the slurry was purged with nitrogen gas for 1 hour followed by addition of ascorbic acid solution 150 mg in 100 ml water (purged with N₂ gas for 1 hour). The thick mass was stirred for 2 hr and then neutralized with KOH solution 45% after extrusion of the gel to pH 7.2-7.5. The dough was washed by stirring with methanol (3.0 kg) to afford granulated product. Weight—260 g, yield—97% with moisture content 6-7% Water absorbing capacity (WAC)=615 g/g

### Example 7: Process for Preparation of Superabsorbent Polymers

656 g of starch was hydrated/gelatinized at 85° C. in 6985 g of water in a homogenizer for 2.5 hr in a bucket. The mixture was cooled to 30° C. and to this mass 1024 g of acrylic acid was added followed by 4.24 g TEGDA. The mass was transferred to the ribbon paddle reactor and N₂ was purged. Parallelly, N₂ purged into 810 ml water having 1.23 g ascorbic acid solution was also prepared in a separate vessel. After 45 minutes, 2.45 g APS (ammonium persulfate) was added to the slurry in the ribbon paddle reactor and N₂ purging is continued. Ascorbic acid solution was introduced into the ribbon paddle reactor after 15 minutes (total time 1 hr) in 1 min at 28-30° C. Stirring was done for 1 minute and then RPM was reduced to 3-4. The dough formed was extruded and transferred back to the reactor for neutralization in a neutralization chamber using a 50% solution of potassium carbonate. The neutralized dough (pH 7-8) was then granulated by mixing with methanol and dried. Weight—2018 g, Yield—95% with moisture content 5-7%. Water absorbing capacity (WAC)=722 g/g.

1. A process for the production of a superabsorbent polymer, the process comprising:
a) graft polymerizing a monomer on a polysaccharide to form a copolymer; and
b) neutralizing the copolymer to obtain the superabsorbent polymer.

2. The process as claimed in claim 1, wherein the monomer is selected from acrylic acid, 2-acrylamido-2-methyl-propanesulfonic acid, methacrylic acid, vinyl sulfonic acid, ethyl acrylate, potassium acrylate, derivatives thereof, and mixtures thereof.

3. The process as claimed in claim 1, wherein said monomer is acrylic acid and the polysaccharide is selected from starch, cellulose, and derivatives thereof.

4. The process as claimed in claim 1, wherein said copolymer is a polysaccharide grafted copolymer.

5. The process as claimed in claim 1, wherein the process is carried out at room temperature.

6. The process as claimed in claim 1, wherein graft polymerization of the monomer on the polysaccharide is carried out in the presence of a catalytic system comprising ammonium persulfate, cross linking agent, and ascorbic acid.

7. The process as claimed in claim 6, wherein crosslinking agent is selected from glycerides, diepoxides, diglycidyls, cyclohexadiamide, methylene bis-acrylamide, bis-hydroxyalkylamides, bis-hydroxypropyl adipamide, formaldehydes, urea-formaldehyde, tetra (ethylene glycol) diacrylate, 1,6-hexanediol dimethacrylate, 1,3-butanediol dimethacrylate, melamine-formaldehyde resins, isocyanates epoxy resins, derivatives, and mixtures thereof.

8. The process as claimed in claim 1, wherein a mole ratio of the polysaccharide to the monomer is in the range from 1:10 to 10:1.

9. The process as claimed in claim 1, wherein polymerization in step a) is carried out in the absence of acrylamide.

10. The process as claimed in claim 1, wherein neutralization of the copolymer is carried out using an alkali metal alkoxide, a hydroxide of an alkali metal, a carbonates of an alkali metal, a bicarbonate salt of an alkali metal, or a mixture thereof.

11. The process as claimed in claim 1, wherein the superabsorbent polymer is selected from a copolymer of acrylamide and sodium acrylate; hydrolyzed starch-polyacrylonitrile; 2-propenenitrile homopolymer, hydrolyzed, sodium salt or poly(acrylamide co-sodium acrylate) or poly(2-propenamide-co-2-propanoic acid, sodium salt); starch-g-poly(2propenamide-co-2-propanoic acid, mixed sodium and aluminium salts); starch-g-poly(2-propenamide-co-2-propanoic acid, potassium salt); poly(2-propenamide-co-2-propanoic acid, sodium salt); poly-2-propanoic acid, sodium salt; starch-gpoly(acrylonitrile) or poly(2-propenamide-co-sodium acrylate); starch/acrylonitrile copolymer; crosslinked copolymers of acrylamide and sodium acrylate; acrylamide/sodium polyacrylate crosslinked polymers; anionic polyacrylamide; starch grafted sodium polyacrylates; acrylic acid polymers, sodium salt; crosslinked potassium polyacrylate/polyacrylamide copolymers; sodium polyacrylate; superabsorbent polymer laminates and composites; partial sodium salt of crosslinked polypropenoic acid; potassium polyacrylate, lightly crosslinked; sodium polyacrylate, lightly crosslinked; sodium polyacrylates; poly(sodiumacrylate) homopolymer; polyacrylamide polymers, carrageenan, agar, alginic acid, guar gums and its derivatives, and gellan gum.

12. The process as claimed in claim 1, wherein said superabsorbent polymer is starch-g-poly (2-propenamide-co-2-propenoic acid), or a salt thereof.

13. A superabsorbent polymer having a particle size in the range from 5000 micron to 100 micron.

14. A superabsorbent polymer having water absorbance capacity in the range from 100 to 1500 g/g.

15. A kit comprising:
a container comprising a superabsorbent polymer prepared by process as claimed in claim 1 optionally with at least one plant advantageous additive; and
an instruction manual instructing a user to administer the content to a locus.
